(19) United States
(12) Patent Application Publication
(10) Pub. No.: US 2018/0081324 A1
(43) Pub. Date: Mar. 22, 2018

(54) ALARMING FUNCTIONALITY WITH CONTEXTUAL REACTIVITY

(71) Applicant: Intel Corporation, Santa Clara, CA (US)

(72) Inventors: AVI SHARONI, Kfar-Saba (IL); OREN PEER, Kiryat Ono (IL)

(73) Assignee: Intel Corporation, Santa Clara, CA (US)

(21) Appl. No.: 15/270,336

(22) Filed: Sep. 20, 2016

(51) Int. Cl. G04G 13/02

(52) U.S. Cl. CPC G04G 13/021

(57) ABSTRACT

This disclosure is directed to a system including alarming functionality with contextual reactivity. Alarming functionality may be implemented in an alarm system to determine when to generate an alarm. A user may activate the alarming functionality without specifying an alarm time. The alarming functionality may then utilize context information to propose an alarm time. The user may then approve the alarm time. In the duration of time that follows, the alarming functionality may cause the context information to be updated. The alarming functionality may determine if the alarm time should be updated based on the updated context information, and may proceed to adjust the alarm time accordingly. An alarm may then be generated at the alarm time. The alarming functionality may further receive sensor information, and may use the sensor information to determine, for example, whether to regenerate the alarm or deactivate the alarm.

### TECHNICAL FIELD

The present disclosure relates to electronic device operation, and more particularly, to at least one device comprising alarming functionality capable of reacting to contextual information.

### BACKGROUND

Timepieces including alarming functionality have evolved greatly from first conception. A need was determined to exist when first morning's light was not enough to wake an exhausted individual. Early solutions necessitated winding a spring-driven alarm clock that would generate an alarm bell at a set time. Early alarm clocks were followed by electromechanical devices that would flip through lighted numbers. These clocks included buzzers or radios that would go off at a preset time. Modern alarm clocks may be solid state (e.g., fully implemented using digital circuitry) and may comprise features such as multiple preset alarm times, gradually increasing alarm generation (e.g., slowly increasing alarm volume and/or light intensity) and other similarly useful features. However, all existing alarming solutions still necessitate the operations of a user determining when alarms need to be generated and the user then programming fixed alarm times.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example system including alarming functionality with contextual reactivity in accordance with at least one embodiment of the present disclosure;

FIG. 2 illustrates an example configuration for devices usable in accordance with at least one embodiment of the present disclosure;

FIG. 3 illustrates an example configuration for alarming functionality in accordance with at least one embodiment of the present disclosure;

FIG. 4 illustrates example operations for alarm configuration in accordance with at least one embodiment of the present disclosure; and

FIG. 5 illustrates example operations for alarm generation in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

This disclosure is directed to a system including alarming functionality with contextual reactivity. In general, alarming functionality may be implemented in an alarm system (e.g., on local and/or remote devices) to determine when to generate an alarm. A user may activate the alarming functionality without specifying an alarm time. The alarming functionality may then utilize context information regarding the user, the user's schedule, the user's environment, etc. when proposing an alarm time. The user may then approve the alarm time. In the duration of time that follows, the alarming functionality may cause the context information to be updated. The alarming functionality may determine if the alarm time should be updated based on the updated context information, and may proceed to adjust the alarm time accordingly. An alarm may then be generated at the alarm time. Moreover, the alarming functionality may further receive sensor information (e.g., as a part of the context information), and may use the sensor information to determine, for example, whether to regenerate the alarm or deactivate the alarm.

In at least one embodiment, at least one device including alarming functionality with contextual reactivity may comprise, for example, communication circuitry, memory circuitry, processing circuitry and user interface circuitry. The communication circuitry may be to receive contextual information. The memory circuitry may be to store code and at least one alarm configuration. The processing circuitry may be to execute at least a portion of the code to implement alarming functionality in the memory circuitry, wherein the alarming functionality is to determine the at least one alarm configuration based at least on the contextual information. The user interface circuitry may be to receive user input and generate at least one alarm based on the alarm configuration.

In at least one embodiment, the alarming functionality may be implemented substantially in a first device and the user interface circuitry resides in a second device. Given this example implementation, each of the first and second devices may comprise a set of communication circuitry to facilitate interaction between the processing circuitry and the user interface circuitry via wired or wireless communication. The alarming functionality may comprise an alarm handler in the first device to interact with an alarm optimization listener in the second device.

In at least one embodiment, the alarming functionality may comprise at least one contextual information provider to cause the communication circuitry to transmit at least one request for the contextual information. The alarming functionality may further comprise an alarm database and an alarm optimization engine to determine a wakeup time and store the wakeup time as part of the alarm configuration in the alarm database. In at least on example implementation, the alarming functionality may be to cause the user interface circuitry to present the alarm configuration to a user for approval. The alarming functionality may be to cause the contextual information to be updated following the user approval, determine if the updated contextual information affects the alarm configuration and adjust the alarm configuration based on determining that the updated contextual information affects the alarm configuration.

In at least one embodiment, the user interface circuitry may comprise at least one sensor to provide sensor information to the alarming functionality. The alarming functionality may be to update the alarm configuration based on the sensor information. In at least one example implementation, the alarming functionality may be to cause the user interface circuitry to repeat the alarm generation based on the sensor information. Consistent with the present disclosure, an example method for alarm configuration with contextual reactivity may comprise activating alarming utilizing user interface circuitry in a device, determining contextual information in the device or another device, determining an alarm configuration in the device or another device, storing the alarm configuration in the device or another device and causing the user interface circuitry to generate an alarm based on the alarm configuration.

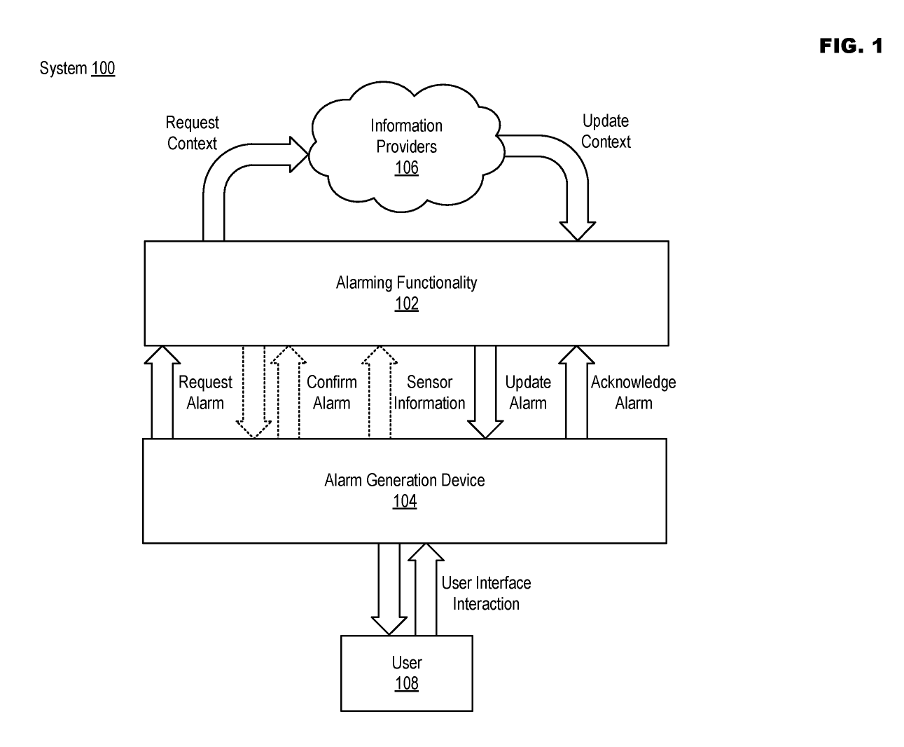

FIG. 1 illustrates an example system including alarming functionality with contextual reactivity in accordance with at least one embodiment of the present disclosure. The following disclosure may make reference to, or may use terminology commonly associated with, certain technologies such as certain device configurations, types of wireless communication, sensors, etc. These references have been employed herein merely for the sake of explanation, and are not intended to limit embodiments consistent with the present disclosure to any particular manner of implementation. While these examples may provide a basis for understanding the embodiments, actual implementations may employ other technologies existing now or developed in the future. The inclusion of an apostrophe after an item number (e.g., 100′) in the disclosure may indicate that an example embodiment of the particular item is being shown. The illustrated examples are also not intended to limit the various embodiments to any particular manner of implementation.

Referring to FIG. 1, system 100 may provide alarming functionality 102 to one or more alarm generation devices 104. While alarming functionality 102 may service a variety of alarm generation devices 104, for the sake of clarity the embodiments of the present disclosure will be discussed using only one alarm generation device 104. Alarming functionality 102 may employ context information obtained from information providers 106 to configure alarm times for alarm generation device 104, update alarm times, make determinations whether to regenerate an alarm or deactivate an alarm, etc. Alarming functionality 102 and alarm generation device 104 may be implemented using hardware (e.g., circuitry and firmware), software or combinations thereof. For example, alarm generation device 104 may be any apparatus configurable to receive an input (e.g., user input, sensor information, alarm time, etc.) and generate an output (e.g., an alarm). In at least one embodiment, alarming functionality 102 may be implemented as software on alarm generation device 104. In another embodiment, alarming functionality 102 may be implemented on one or more devices that may be situated apart from alarm generation device 104. Examples of devices usable to implement alarming functionality 102 and/or alarm generation device 104 may include, but are not limited to, a mobile communication device such as a cellular handset or a smartphone based on the Android® OS from the Google Corporation, iOS® or Mac OS® from the Apple Corporation, Windows® OS from the Microsoft Corporation, Tizen® OS from the Linux Foundation, Firefox® OS from the Mozilla Project, Blackberry® OS from the Blackberry Corporation, Palm® OS from the Hewlett-Packard Corporation, Symbian® OS from the Symbian Foundation, etc., a mobile computing device such as a tablet computer like an iPad® from the Apple Corporation, Surface® from the Microsoft Corporation, Galaxy Tab® from the Samsung Corporation, Kindle® from the Amazon Corporation, etc., an Ultrabook® including a low-power chipset from the Intel Corporation, a netbook, a notebook, a laptop, a palmtop, etc., a wearable device such as a wristwatch form factor computing device like the Galaxy Gear® from Samsung, an eyewear form factor computing device/user interface like Google Glass® from the Google Corporation, a virtual reality (VR) headset device like the Gear VR® from the Samsung Corporation, the Oculus Rift® from the Oculus VR Corporation, etc., a typically stationary computing device such as a desktop computer, a server, a group of computing devices organized in a high performance computing (HPC) architecture, a smart television or other type of “smart” device, small form factor computing solutions (e.g., for space-limited applications, TV set-top boxes, etc.) like the Next Unit of Computing (NUC) platform from the Intel Corporation, etc.

The arrows depicted in FIG. 1 demonstrate interaction that may occur between alarming functionality 102, alarm generation device 104, information providers 106 and user 108. While it may be possible to implement alarming functionality 102 within alarm generation device 104, example system 100 illustrates interaction when alarming functionality 102 is implemented in a separate device. For example, user 108 may wear alarm generation device 104 (e.g., a wearable device such a smartwatch) configured to interact with alarming functionality 102 operating in at least one remotely located device. “Remotely-located” implementations may include alarming functionality 102 being implemented in at least one device accessible via a local-area network (LAN), a wide-area network (WAN) such as the Internet, a global-area network (GAN), etc. For example, alarming functionality 102 may be hosted within a cloud-based architecture wherein at least one device (e.g., a server) is accessible to alarm generation device 104 via the Internet. In some instances, an intermediary device (e.g., a smartphone) may act as a bridge allowing alarm generation device 104 (e.g., a smartwatch) to access alarming functionality 102 via the Internet.

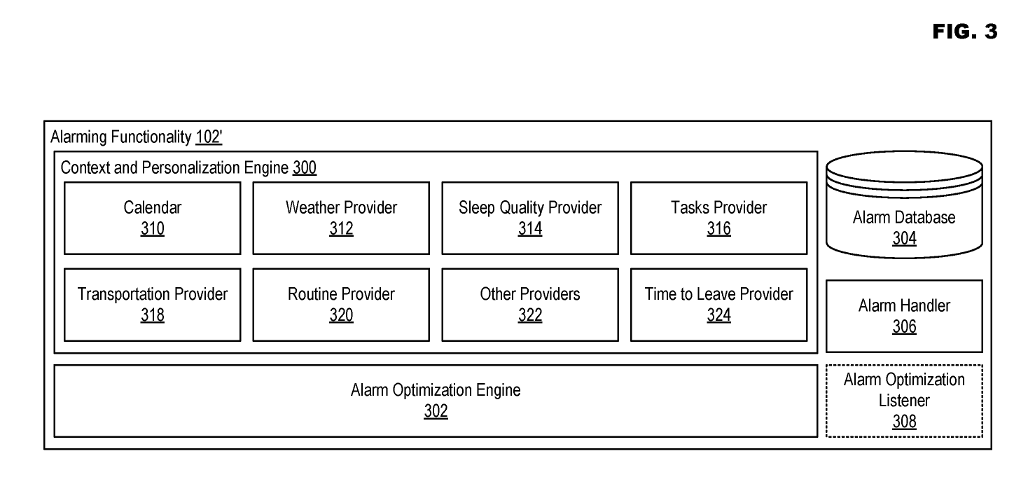

In an example of operation, user 108 may interact with alarm generation device 104 to request alarming. For example, a user may interact with alarm generation device 104 to trigger the execution of an application usable to configure system 100. The user interaction may include triggering a request for alarming. In at least one embodiment, an alarm time is not requested up-front, which allows system 100 (e.g., alarming functionality 102) to propose an alarm time. The request for alarming may cause alarming functionality 102 to request context information from information providers 106. Information providers 106 may comprise local and remote elements that may operate to provide a variety of context information to alarming functionality 102. The context information may correspond to user 108, the user's schedule, the user's environment, the various modes of transportation available to the user, etc. Example configurations for alarming functionality 102 and information providers 106 will be discussed in detail in regard to FIG. 3.

In at least one embodiment, alarming functionality 102 may use the context information to propose an alarm time to user 108. This may be best understood through an example scenario. User 108 may request a wakeup alarm for the following morning. Alarming functionality 102 may request context information for determining a wakeup time. The context information may include, for example, the user's physical condition (e.g., health, amount of sleep the previous night, etc.), the user's schedule, the user's family situation, the condition of the user's vehicles, the weather, the condition of the roads on the possible routes the user may travel (e.g., traffic, construction, weather-induced conditions, etc.), events that may be scheduled for the next day (e.g., parades, sporting events, etc.), errands/tasks to which the user must attend, etc. Alarming functionality 102 may employ the context information to determine that, for example, user 108 did not have a sound night of sleep the night before, has a meeting scheduled for 8:00 AM, it is winter and snow is forecast for tomorrow morning, there is construction on a highway user 108 typically takes to work, the car of user 108 is low on gas, a child of user 108 has a doctor's appointment scheduled for tomorrow morning, there is a parade planned to celebrate the victory of a local sports team that will pass near the office of user 108, etc. Taking all of this context information into account, alarming functionality 102 may propose a wakeup time that will allow user 108 to arrive at work in time for the 8:00 AM meeting. User 108 may then approve the proposed wakeup time or may request a new determination.

However, the approval of user 108 does not simply set the wakeup alarm for the proposed time. Alarming functionality 102 may continue to obtain updated context information. Context information may be requested (“pulled”) by alarming functionality 102 or provided (“pushed”) by information providers 106 on a periodic basis, upon request, upon change, etc. Moreover, in an instance that alarm generation device 104 is wearable (e.g., or is at least coupled to a wearable device), sensor information may be provided to alarming functionality 102 for use in determining the condition of user 108. For example, motion sensors in the wearable device may provide data that is indicative of the movement of a user during sleep. This movement may be determinative of poor sleep, sleep cycles, etc. Alarming functionality 102 may consider the updated context information (e.g., including the sensor information) when determining whether the wakeup time needs to be changed to be earlier or later. Continuing with the previous example, the meeting being rescheduled from 8:00 AM to 9:00 AM may cause alarming functionality 102 to push the wakeup time out, while an accident occurring on the route that user 108 typically takes to work may be cause to make the wakeup time earlier. An increased in the motion of a sleeping user being detected may be used to conclude that user 108 is coming to the end of a sleep cycle, which may cause alarming functionality 102 to wake user 108 up now (e.g., generate an alarm now instead of 20 minutes from now) to prevent user 108 from entering into another sleep cycle. Waking user 108 at the end of a sleep cycle may be conducive to user 108 feeling like he/she got a better night of sleep.

Moreover, sensor information may also be used to ensure that user 108 is actually awake. For example, alarm generation device 104 may generate an alarm for a certain amount of time. Sensors within (or coupled to) alarm generation device 104 may then provide information about the activity of user 108. If the motion of user 108 stops (e.g., it appears that user 108 has returned to sleep) alarm generation device 104 may generate the alarm again (possibly louder combined with tactile feedback). Alarming may be deactivated once user 108 is sensed to be in constant motion. In at least one embodiment, alarming functionality 102 and/or alarm generation device 104 may provide a schedule of events to assist user 108 in remaining on schedule. For example, alarm generation device 104 may display the next event (e.g., “take shower by 6:45 AM) or next few events so that user 108 is aware of what events must occur in order to remain on schedule.

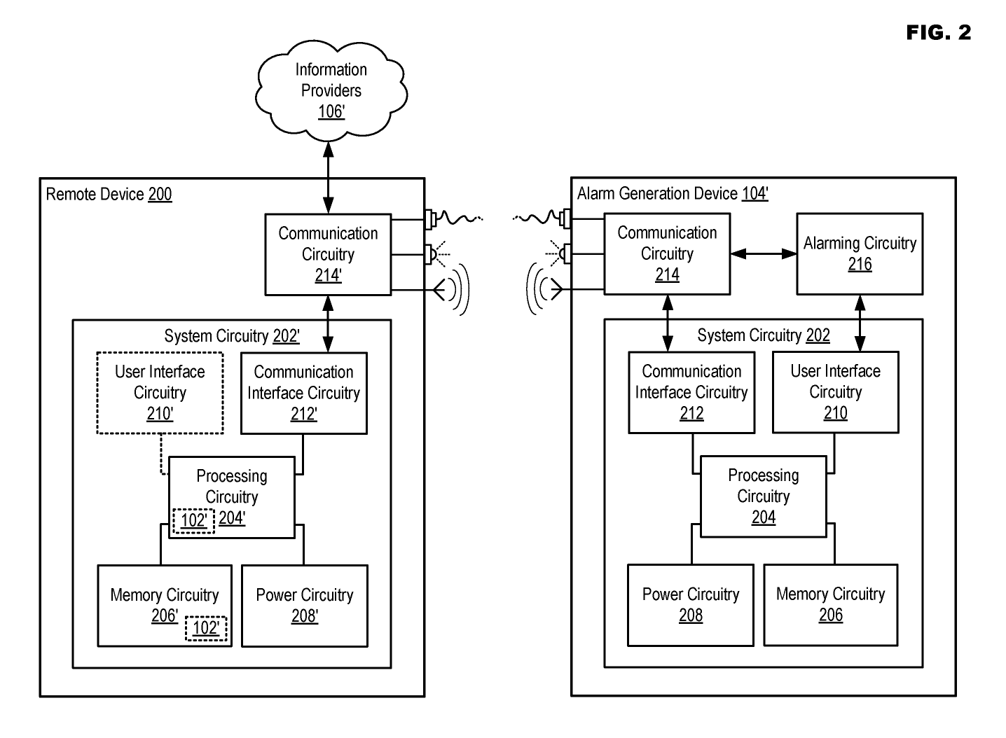

FIG. 2 illustrates an example configuration for devices usable in accordance with at least one embodiment of the present disclosure. Alarm generation device 104′ and/or remote device 200 may be capable of performing any or all of the activities discussed with respect to FIG. 1. However, devices 104′ and 200 are presented only as examples of apparatuses usable in various embodiments consistent with the present disclosure, and are not intended to limit any of the various embodiments disclosed herein to any particular manner of implementation. Moreover, while only one remote device 200 is illustrated, the functionality attributed to remote device 200 may be performed by a single device or multiple devices configured to operate collaboratively.

An example alarm generation device 104′ may comprise, for example, system circuitry 202 to manage general device operations. System circuitry 202 may include processing circuitry 204, memory circuitry 206, power circuitry 208, user interface circuitry 210 and communication interface circuitry 212. Alarm generation device 104′ may also include communication circuitry 214 and alarming circuitry 216. While communication circuitry 214 and alarming circuitry 216 are illustrated as separate from system circuitry 202, this example configuration is shown merely for the sake of explanation. Some or all of the functionality associated with communication circuitry 214 and/or alarming circuitry 216 may also be incorporated into system circuitry 202. In alarm generation device 104′, processing circuitry 204 may comprise one or more processors situated in separate components, or alternatively one or more processing cores in a single component (e.g., in a system-on-chip (SoC) configuration), along with processor-related support circuitry (e.g., bridging interfaces, etc.). Example processors may include, but are not limited to, various x86-based microprocessors from the Intel Corporation including those in the Pentium®, Xeon®, Itanium®, Celeron®, Intel Atom®, Quark®, Core i-series and Core M-series product families, Reduced Instruction Set Computing (RISC) processors such as Advanced RISC Machine (ARM) processors, etc. Example support circuitry may include various chipsets (e.g., Northbridge, Southbridge, etc. from the Intel Corporation) configured to provide an interface through which processing circuitry 204 may interact with other system components that may be operating at different speeds, on different buses, etc. in alarm generation device 104′. Moreover, some or all of the functionality associated with the support circuitry may be included in the same physical package as the processor (e.g., such as in the Sandy Bridge, Broadwell and Skylake families of processors from the Intel Corporation).

Processing circuitry 204 may be configured to execute instructions in alarm generation device 104′. Instructions may include program code configured to cause processing circuitry 204 to perform activities related to reading data, writing data, processing data, formulating data, converting data, transforming data, etc. Information (e.g., instructions, data, etc.) may be stored in memory circuitry 206. Memory circuitry 206 may comprise random access memory (RAM) and/or read-only memory (ROM) in a fixed or removable format. RAM may include volatile memory configured to hold information during the operation of alarm generation device 104′ such as, for example, static RAM (SRAM) or dynamic RAM (DRAM). ROM may include non-volatile (NV) memory circuitry configured based on BIOS, UEFI, etc. to provide instructions when alarm generation device 104′ is activated, programmable memories such as electronic programmable ROMs (EPROMS), Flash, etc. Other examples of fixed/removable memory may include, but are not limited to, magnetic memories such as hard disk (HD) drives, etc., electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), Digital Video Disks (DVD), Blu-Ray Disks, etc.

Power circuitry 208 may include internal power sources (e.g., a battery, fuel cell, etc.) and/or external power sources (e.g., electromechanical or solar generator, power grid, external fuel cell, etc.), and related circuitry configured to supply alarm generation device 104′ with the power needed to operate. User interface circuitry 210 may include hardware and/or software to allow users to interact with alarm generation device 104′ such as, for example, various input mechanisms (e.g., microphones, switches, buttons, knobs, keyboards, speakers, touch-sensitive surfaces, one or more sensors configured to capture images and/or sense proximity, distance, motion, gestures, orientation, biometric data, etc.) and various output mechanisms (e.g., speakers, displays, lighted/flashing indicators, electromechanical components for vibration, motion, etc.). The hardware in user interface circuitry 210 may be incorporated within alarm generation device 104′ and/or may be coupled to alarm generation device 104′ via a wired or wireless communication medium.

Communication interface circuitry 212 may be configured to manage packet routing and other control functions for communication circuitry 214 that may include resources configured to support wired and/or wireless communications. In some instances, alarm generation device 104′ may comprise more than one set of communication circuitry 214 (e.g., including separate physical interface circuitry for wired protocols and/or wireless radios) managed by communication interface circuitry 212. Wired communications may include serial and parallel wired mediums such as, for example, Ethernet, USB, Firewire, Thunderbolt, Digital Video Interface (DVI), High-Definition Multimedia Interface (HDMI), etc. Wireless communications may include, for example, close-proximity wireless mediums (e.g., radio frequency (RF) such as based on the RF Identification (RFID) or Near Field Communications (NFC) standards, infrared (IR), etc.), short-range wireless mediums (e.g., Bluetooth®, WLAN, Wi-Fi, etc.), long range wireless mediums (e.g., cellular wide-area radio communication technology, satellite-based communications, etc.), electronic communications via sound waves, long-range optical communications, etc. In at least one embodiment, communication interface circuitry 212 may be configured to prevent wireless communications that are active in communication circuitry 214 from interfering with each other. In performing this function, communication interface circuitry 212 may schedule activities for communication circuitry 214 based on, for example, the relative priority of messages awaiting transmission. While the embodiment disclosed in FIG. 2 illustrates communication interface circuitry 212 being separate from communication circuitry 214, it may also be possible for the functionality of communication interface circuitry 212 and communication circuitry 214 to be incorporated into the same circuitry.

In at least one embodiment, alarming circuitry 216 may include hardware and/or software to schedule/generate an alarm in alarm generation device 104′. For example, alarming circuitry 216 may interact with at least communication circuitry 214 to receive an alarm configuration from alarming functionality 102′. An example alarming configuration may include a wakeup time (e.g., a time at which to generate the alarm), what type of alarm to generate (e.g., audible, visible, tactile), files corresponding to the selected type of alarm (e.g., audio files that may be selected by user 108), whether the alarm should be repeated (e.g., snooze functionality), etc. Alarming circuitry 216 may also interact with user interface circuitry 210. For example, user interface circuitry 210 may be triggered by alarming circuitry 216 to actually generate the alarm. Remote device 200 may include circuitry similar to alarm generation device 104′ except that the actual implementation of the circuitry will vary depending on the type of device (e.g., a wearable device vs. a server). For example, the general functional aspects of system circuitry 202′, processing circuitry 204′, memory circuitry 206′, power circuitry 208′, communication interface circuitry 212′ and communication circuitry 214′ may correspond to circuitry 202, 204, 206, 208, 212 and 214 as described above. User interface circuitry 210′ may be optional in certain circumstances such as, for example, a situation wherein remote device 200 is a very small form factor device configured remotely (e.g., wirelessly) by another device, a server (e.g., rack server, blade server, etc.) that does not include user interface circuitry 210, and instead relies on another device (e.g., a management terminal) for user interface functionality, etc. Consistent with the present disclosure, alarming functionality 102′ may comprise hardware, software or combinations thereof. For example, alarming functionality 102′ be implemented as a standalone integrated circuit or be a part of other circuitry (e.g., processing circuitry 204′). In an example combined software/hardware implementation, at least a portion of alarming functionality 102′ may reside in processing circuitry 204′ and/or memory circuitry 206′. For example, alarming functionality 102′ may comprise code executed by processing circuitry 204′, wherein at least a portion of the code may be stored in memory circuitry 206′. Executing the code may transform processing circuitry 204′ from general purpose data processing circuitry (e.g., a microprocessor) into specialized circuitry to perform at least the functions associated with alarming functionality 102′. In an example of operation, alarming functionality 102′ may interact with communication circuitry 214′ to receive an alarming request from alarm generation device 104′, request context information from information providers 106′, receive the requested context information and then provide an alarm configuration including at least a wakeup time to alarm generation device 104′.

FIG. 3 illustrates an example configuration for alarming functionality in accordance with at least one embodiment of the present disclosure. Alarming functionality 102′ may include, for example, context and personalization engine 300, alarm optimization engine 302, alarm database 304, alarm handler 306 and optionally alarm optimization listener 308 (e.g., alarm optimization listener 308 may also exist in alarm generation device 104). Context and personalization engine 300 may comprise one or more information providers (e.g., 310 to 324) configured to obtain and update context information. In at least one embodiment, information providers 310 to 324 may be hardware and/or software (e.g., sections of code, programs, etc.) configured to obtain context information from various remote resources including, for example, websites, databases, services that provide information, etc. For example, calendar 310 may track scheduled events for user 108 at least for the period of time relevant to a requested alarm. Weather provider 312 may track the current or forecast weather condition. Sleep quality provider 314 may track sleep patterns for user 108 (e.g., based on sensing the motion of user 108 or other inputs from user 108). Tasks provider 316 may track a “to-do” list for user 108 including, for example, required and/or optional stops to be made to and from work. Transportation provider 318 may track the status of the various modes of transportation available to user 108. For example, if user 108 drives to work then transportation provider 318 may track the status of the car of user 108 (e.g., a control system within the car may self-report fuel level, required maintenance, etc.), the status of construction, accidents, traffic, etc. on a preferred route and possibly alternative routes, etc. If user 108 rides public transportation to work, then transportation provider 318 may track the on-time status of public transportation, if any problems have been reported along the route traveled by user 108, etc. Routine provider 320 may track the morning routine of user 108 including, for example, the times user 108 typically spends working out, showering, eating breakfast, feeding pets, reading the paper, etc. prior to leaving for work. Other providers 322 (e.g., beyond the specific examples shown in FIG. 3) may be utilized based on configuration (e.g., automatically determined by system 100, manually selected by user 108, etc.). Time to leave provider 324 may then accumulate the context information provided by the other providers to determine when user 108 needs to depart for his/her intended destination.

Alarm optimization engine 302 may then determine a wakeup time based on the context information provided by context and personalization engine 300. In at least one embodiment, sensor information may also be considered. For example, alarm optimization engine 302 may comprise at least one algorithm for determining a wakeup time allow for user 108 to arrive at an intended destination in time for required/desired activities while considering the typical morning routine of user 108 and other factors that could impede the progress of user 108. Consistent with the present disclosure, alarm optimization engine 302 may propose the wakeup time to user 108 prior to storing wakeup time in alarm database 304. Alarm handler 306 may interact with context and personalization engine 300 and/or alarm optimization engine 302 to at least determine whether the wakeup time needs to be modified (e.g., made earlier or later). For example, a change in the context information (e.g., a meeting being moved, an accident, user 108 completing a sleep cycle, etc.) may cause the wakeup time to change. Alarm optimization listener 308 may be configured to trigger alarm generation device 104 to generate an alarm based on the wakeup time configured by alarm optimization engine 302 and/or alarm handler 306. Depending on the configuration of system 100, alarm optimization listener 308 may reside in alarming functionality 102′ or alarm generation device 104. For example, if alarm generation device 104 has limited data processing ability, alarm optimization listener 308 may reside in alarming functionality 102′ and may, when it is time to generate an alarm, transmit an alarm trigger signal to alarm generation device 104.

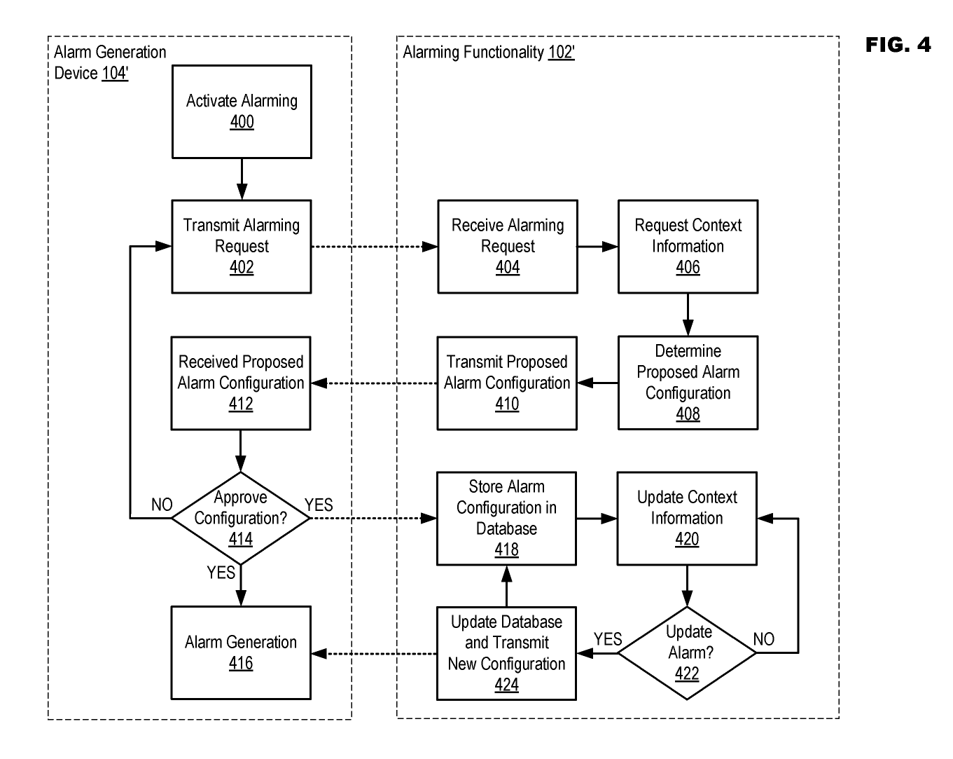

FIG. 4 illustrates example operations for alarm configuration in accordance with at least one embodiment of the present disclosure. As shown in FIG. 4, operations 400, 402, 412 to 416 may be performed by alarm generation device 104′, while operations 404 to 410 and 418 to 424 may be performed by alarming functionality 102′. Alarming may be activated in operation 400. For example, a user interface (e.g., an application that may be accessed through a physical user interface) may be provided allowing a user to request a wakeup time proposal for consideration. In operation 402 an alarming request may be transmitted to alarming functionality that receives the request at 404. Context information may then be requested in operation 406. For example, alarming functionality 102′ may request context information from at least one provider, receive sensor information from at least one sensor in a wearable device (e.g., alarm generation device 104′), etc. A proposed alarm configuration may then be determined based at least on the current information in operation 408, the proposed alarm configuration comprising at least an alarm time (e.g., wakeup time). In operation 410 the proposed alarm configuration may be transmitted. The proposed alarm configuration may be received by alarm generation device 104′ in operation 412.

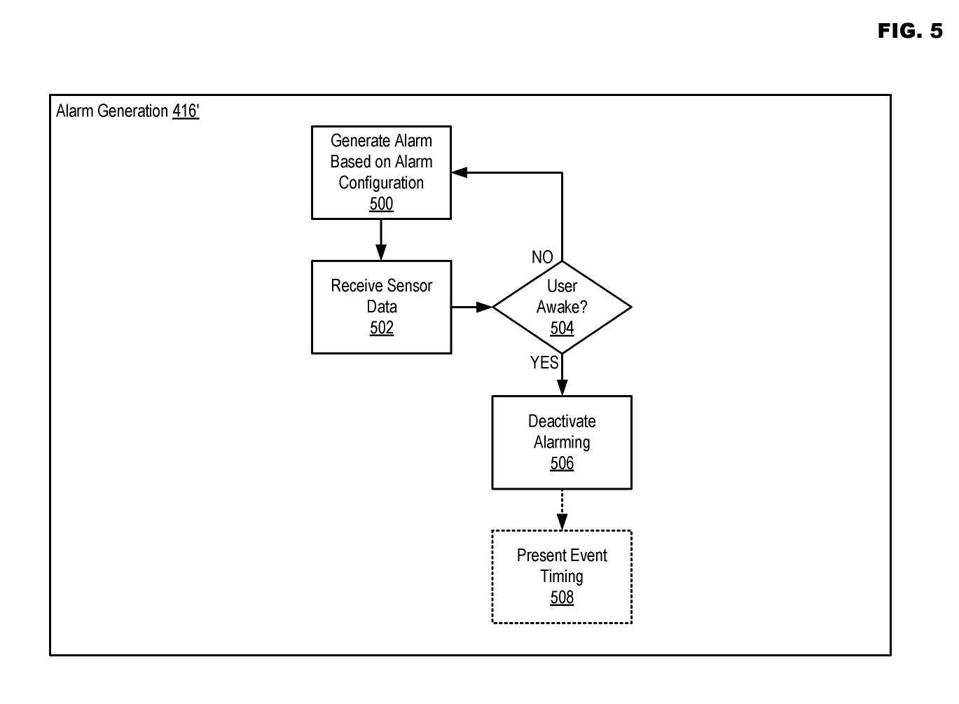

A determination may then be made in operation 414 as to whether the user has approved the proposed alarm configuration. In at least one embodiment, the proposed alarm configuration may be presented by alarm generation 104′ device, and the user may approve/reject the proposed alarm configuration (e.g., via interaction with the user interface of alarm generation device 104′). A determination that the proposed alarm configuration has been rejected by the user in operation 414 may be followed by a return to operation 402 for alarming functionality 102′ to reformulate the proposed alarm configuration. If in operation 414 it is determined that the proposed alarm configuration has been approved by the user, then subsequent operations may occur in each of alarm generation device 104′ and alarming functionality 102′. In alarm generation device 104′ the alarm configuration may be set for eventual alarm generation in operation 416. Additional detail regarding the operations involved in alarm generation 416 will be disclosed in FIG. 5. In addition, in operation 418 the alarm configuration may be stored to an alarm database.

In operation 420 the context information may be updated. A determination may then be made in operation 422 as to whether the updated context information will cause a change in the alarm configuration. For example, updates in the context information such as a schedule change, an accident, etc. may warrant a change to the alarm configuration. A determination in operation 422 that the updated context does not affect the alarm configuration may be followed by a return to operation 420 to again update the context information. If in operation 422 it is determined that the updated context information will affect the current alarm configuration, then in operation 424 the new alarm configuration may be stored in the alarm database. The new alarm configuration may also be provided to alarm generation device 104′ to update the setting for alarm generation operation 416. In at least one embodiment, operations 418 to 422 may continue to loop to update the context information/alarm configuration until alarm generation is triggered in operation 416.

FIG. 5 illustrates example operations for alarm generation in accordance with at least one embodiment of the present disclosure. In operation 500 an alarm may be generated based on the alarm configuration. Sensor data may then be received in operation 502. The sensor data may be received from, for example, a wearable device (e.g., alarm generation device 104′) currently being worn by the user. A determination may then be made in operation 504 as to whether the user is actually awake. This determination may be based on, for example, motion sensed in the user by the wearable device. A determination in operation 504 that the user is not awake may be followed by a return to operation 504 to again generate the alarm (e.g., possibly after some time delay such as in a manual snooze operation). If in operation 504 it is determined that the user is awake, then in operation 506 alarming may be deactivated. Optionally (e.g., depending on the configuration of system 100, the abilities of alarm generation device 104′, etc.) in operation 508 event timing may be presented to the user. Event timing may comprise, for example, one or more activities scheduled for the near future. The event timing may apprise the user of what activities the user must complete in a certain time period for the user to remain on schedule.

While FIGS. 4 and 5 illustrates operations according to different embodiments, it is to be understood that not all of the operations depicted in FIGS. 4 and 5 are necessary for other embodiments. Indeed, it is fully contemplated herein that in other embodiments of the present disclosure, the operations depicted in FIGS. 4 and 5, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device.

Thus, this disclosure is directed to a system including alarming functionality with contextual reactivity. Alarming functionality may be implemented in an alarm system to determine when to generate an alarm. A user may activate the alarming functionality without specifying an alarm time. The alarming functionality may then utilize context information to propose an alarm time. The user may then approve the alarm time. In the duration of time that follows, the alarming functionality may cause the context information to be updated. The alarming functionality may determine if the alarm time should be updated based on the updated context information, and may proceed to adjust the alarm time accordingly. An alarm may then be generated at the alarm time. The alarming functionality may further receive sensor information, and may use the sensor information to determine, for example, whether to regenerate the alarm or deactivate the alarm.

The following examples pertain to further embodiments. The following examples of the present disclosure may comprise subject material such as a device, a method, at least one machine-readable medium for storing instructions that when executed cause a machine to perform acts based on the method, means for performing acts based on the method and/or a system including alarming functionality with contextual reactivity.

According to example 1 there is provided at least one device including alarming functionality with contextual reactivity. The at least one device may comprise communication circuitry to receive contextual information, memory circuitry to store code and at least one alarm configuration, processing circuitry to execute at least a portion of the code to implement alarming functionality in the memory circuitry, wherein the alarming functionality is to determine the at least one alarm configuration based at least on the contextual information and user interface circuitry to receive user input and generate at least one alarm based on the alarm configuration.

Example 2 may include the elements of example 1, wherein the alarming functionality is implemented substantially in a first device and the user interface circuitry resides in a second device.

Example 3 may include the elements of example 2, wherein the alarming functionality resides in a local computing device or in a remotely-situated computing device accessible via a network.

Example 4 may include the elements of any of examples 2 to 3, wherein the user interface circuitry resides in a wearable device.

Example 5 may include the elements of any of examples 2 to 4, wherein each of the first and second devices comprise a set of communication circuitry to facilitate interaction between the processing circuitry and the user interface circuitry via wired or wireless communication.

Example 6 may include the elements of example 5, wherein the alarming functionality comprises an alarm handler in the first device to interact with an alarm optimization listener in the second device.

Example 7 may include the elements of any of examples 1 to 6, wherein the alarming functionality comprises at least one contextual information provider to cause the communication circuitry to transmit at least one request for the contextual information.

Example 8 may include the elements of example 7, wherein the at least one contextual information provider comprises at least one of a calendar, a weather provider, a sleep quality provider, a tasks provider, a transportation provider, a routine provider and a time to leave provider.

Example 9 may include the elements of any of examples 1 to 8, wherein the alarming functionality comprises an alarm database and an alarm optimization engine to determine a wakeup time and store the wakeup time as part of the alarm configuration in the alarm database.

Example 10 may include the elements of any of examples 1 to 9, wherein the alarming functionality is to cause the user interface circuitry to present the alarm configuration to a user for approval.

Example 11 may include the elements of example 10, wherein presenting the alarm configuration comprises displaying the alarm configuration to the user and requesting that the user approve or reject the alarm configuration.

Example 12 may include the elements of any of examples 10 to 11, wherein the alarming functionality is to cause the contextual information to be updated following the user approval, determine if the updated contextual information affects the alarm configuration and adjust the alarm configuration based on determining that the updated contextual information affects the alarm configuration.

Example 13 may include the elements of any of examples 1 to 12, wherein the user interface circuitry comprises at least one sensor to provide sensor information to the alarming functionality.

Example 14 may include the elements of example 13, wherein the at least one sensor is a motion sensor.

Example 15 may include the elements of any of examples 13 to 14, wherein the alarming functionality is to update the alarm configuration based on the sensor information.

Example 16 may include the elements of any of examples 13 to 15, wherein the alarming functionality is to determine a user sleep cycle based at least on the sensor information and update an alarm time to prevent the user from entering a new sleep cycle.

Example 17 may include the elements of any of examples 13 to 16, wherein the alarming functionality is to cause the user interface circuitry to repeat the alarm generation based on the sensor information.

Example 18 may include the elements of example 17, wherein the alarming functionality is to determine if the user is awake based at least one the sensor information and cause the user interface circuitry to repeat the alarm upon the determination.

Example 19 may include the elements of any of examples 1 to 18 wherein the alarming functionality is to cause the user interface circuitry to present event timing to the user.

Example 20 may include the elements of any of examples 1 to 19, wherein the alarming functionality is implemented substantially in a first device and the user interface circuitry resides in a second device, each of the first and second devices comprising a set of communication circuitry to facilitate interaction between the processing circuitry and the user interface circuitry via wired or wireless communication.

According to example 21 there is provided a method for alarm configuration with contextual reactivity. The method may comprise activating alarming utilizing user interface circuitry in a device, determining contextual information in the device or another device, determining an alarm configuration in the device or another device, storing the alarm configuration in the device or another device and causing the user interface circuitry to generate an alarm based on the alarm configuration.

Example 22 may include the elements of example 21, wherein determining contextual information comprises receiving contextual information from at least one of at least one sensor in the user interface circuitry or from remote information sources accessible via a network.

Example 23 may include the elements of any of examples 21 to 22, wherein determining an alarm configuration comprises determining a wake up time based on the contextual information and storing the wake up time as part of an alarm configuration in an alarm database.

Example 24 may include the elements of any of examples 21 to 23, and may further comprise causing the user interface circuitry to present the alarm configuration to a user, receiving input from the user and confirming the alarm configuration or requesting a new alarm configuration based on the input.

Example 25 may include the elements of any of examples 21 to 24, and may further comprise requesting updated contextual information, determining if the updated contextual information affects the alarm configuration and updating the alarm configuration if the updated contextual information affects the alarm configuration.

Example 26 may include the elements of any of examples 21 to 25, wherein generating an alarm may comprise generating an alarm, receiving sensor information, determining whether the user is awake based at least on the sensor information and regenerating or deactivating the alarm based on whether the user is determined to be awake.

Example 27 may include the elements of example 26, wherein the sensor information is further to determined user sleep cycles.

Example 28 may include the elements of any of examples 26 to 27, and may further comprise causing the user interface circuitry to present event timing to the user.

According to example 29 there is provided a system for alarm configuration with contextual reactivity including at least one device, the system being arranged to perform the method of any of the above examples 21 to 28.

According to example 30 there is provided a chipset arranged to perform the method of any of the above examples 21 to 28.

According to example 31 there is provided at least one machine readable medium comprising a plurality of instructions that, in response to be being executed on a computing device, cause the computing device to carry out the method according to any of the above examples 21 to 28.

According to example 32 there is provided at least one device configured for alarm configuration with contextual reactivity, the at least one device being arranged to perform the method of any of the above examples 21 to 28.

According to example 33 there is provided a system for alarm configuration with contextual reactivity. The system may comprise means for activating alarming utilizing user interface circuitry in a device, means for determining contextual information in the device or another device, means for determining an alarm configuration in the device or another device, means for storing the alarm configuration in the device or another device and means for causing the user interface circuitry to generate an alarm based on the alarm configuration.

Example 34 may include the elements of example 33, wherein the means for determining contextual information comprise means for receiving contextual information from at least one of at least one sensor in the user interface circuitry or from remote information sources accessible via a network.

Example 35 may include the elements of any of examples 33 to 34, wherein the means for determining an alarm configuration may comprise means for determining a wake up time based on the contextual information and means for storing the wake up time as part of an alarm configuration in an alarm database.

Example 36 may include the elements of any of examples 33 to 35, and may further comprise means for causing the user interface circuitry to present the alarm configuration to a user, means for receiving input from the user and means for confirming the alarm configuration or requesting a new alarm configuration based on the input.

Example 37 may include the elements of any of examples 33 to 36, and may further comprise means for requesting updated contextual information, means for determining if the updated contextual information affects the alarm configuration and means for updating the alarm configuration if the updated contextual information affects the alarm configuration.

Example 38 may include the elements of any of examples 33 to 37, wherein the means for generating an alarm comprise means for generating an alarm, means for receiving sensor information, means for determining whether the user is awake based at least on the sensor information and means for regenerating or deactivating the alarm based on whether the user is determined to be awake.

Example 39 may include the elements of example 38, wherein the sensor information is further to determine user sleep cycles.

Example 40 may include the elements of any of examples 38 to 39, and may further comprise means for causing the user interface circuitry to present event timing to the user.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. At least one device including alarming functionality with contextual reactivity, comprising:
communication circuitry to receive contextual information;
memory circuitry to store code and at least one alarm configuration;
processing circuitry to execute at least a portion of the code to implement alarming functionality in the memory circuitry, wherein the alarming functionality is to determine the at least one alarm configuration based at least on the contextual information; and
user interface circuitry to receive user input and generate at least one alarm based on the alarm configuration.

2. The at least one device of claim 1, wherein the alarming functionality is implemented substantially in a first device and the user interface circuitry resides in a second device.

3. The at least one device of claim 2, wherein each of the first and second devices comprise a set of communication circuitry to facilitate interaction between the processing circuitry and the user interface circuitry via wired or wireless communication.

4. The at least one device of claim 3, wherein the alarming functionality comprises an alarm handler in the first device to interact with an alarm optimization listener in the second device.

5. The at least one device of claim 1, wherein the alarming functionality comprises at least one contextual information provider to cause the communication circuitry to transmit at least one request for the contextual information.

6. The at least one device of claim 1, wherein the alarming functionality comprises an alarm database and an alarm optimization engine to determine a wakeup time and store the wakeup time as part of the alarm configuration in the alarm database.

7. The at least one device of claim 1, wherein the alarming functionality is to cause the user interface circuitry to present the alarm configuration to a user for approval.

8. The at least one device of claim 7, wherein the alarming functionality is to cause the contextual information to be updated following the user approval, determine if the updated contextual information affects the alarm configuration and adjust the alarm configuration based on determining that the updated contextual information affects the alarm configuration.

9. The at least one device of claim 1, wherein the user interface circuitry comprises at least one sensor to provide sensor information to the alarming functionality.

10. The at least one device of claim 9, wherein the alarming functionality is to update the alarm configuration based on the sensor information.

11. The at least one device of claim 9, wherein the alarming functionality is to cause the user interface circuitry to repeat the alarm generation based on the sensor information.

12. A method for alarm configuration with contextual reactivity, comprising:
activating alarming utilizing user interface circuitry in a device;
determining contextual information in the device or another device;
determining an alarm configuration in the device or another device;
storing the alarm configuration in the device or another device; and
causing the user interface circuitry to generate an alarm based on the alarm configuration.

13. The method of claim 12, wherein determining contextual information comprises receiving contextual information from at least one of at least one sensor in the user interface circuitry or from remote information sources accessible via a network.

14. The method of claim 12, wherein determining an alarm configuration comprises:
determining a wake up time based on the contextual information; and
storing the wake up time as part of an alarm configuration in an alarm database.

15. The method of claim 12, further comprising:
causing the user interface circuitry to present the alarm configuration to a user;
receiving input from the user; and
confirming the alarm configuration or requesting a new alarm configuration based on the input.

16. The method of claim 12, further comprising:
requesting updated contextual information;
determining if the updated contextual information affects the alarm configuration; and
updating the alarm configuration if the updated contextual information affects the alarm configuration.

17. The method of claim 12, wherein generating an alarm comprises:
generating an alarm;
receiving sensor information;
determining whether the user is awake based at least on the sensor information; and
regenerating or deactivating the alarm based on whether the user is determined to be awake.

18. The method of claim 17, further comprising:
causing the user interface circuitry to present event timing to the user.

19. At least one machine-readable storage medium having stored thereon, individually or in combination, instructions for alarm configuration with contextual reactivity that, when executed by one or more processors, cause the one or more processors to:
activate alarming utilizing user interface circuitry in a device;
determine contextual information in the device or another device;
determine an alarm configuration in the device or another device;
store the alarm configuration in the device or another device; and
cause the user interface circuitry to generate an alarm based on the alarm configuration.

20. The storage medium of claim 19, wherein the instructions to determine contextual information comprise instructions to receive contextual information from at least one of at least one sensor in the user interface circuitry or from remote information sources accessible via a network.

21. The storage medium of claim 19, wherein the instructions to determine an alarm configuration comprise instructions to:
determine a wake up time based on the contextual information; and
store the wake up time as part of an alarm configuration in an alarm database.

22. The storage medium of claim 19, further comprising instructions that, when executed by one or more processors, cause the one or more processors to:
cause the user interface circuitry to present the alarm configuration to a user;
receive input from the user; and
confirm the alarm configuration or requesting a new alarm configuration based on the input.

23. The storage medium of claim 19, further comprising instructions that, when executed by one or more processors, cause the one or more processors to:
request updated contextual information;
determine if the updated contextual information affects the alarm configuration; and
update the alarm configuration if the updated contextual information affects the alarm configuration.

24. The storage medium of claim 19, wherein the instructions to generate an alarm comprise instructions to:
generate an alarm;
receive sensor information;
determine whether the user is awake based at least on the sensor information; and
regenerate or deactivate the alarm based on whether the user is determined to be awake.

25. The storage medium of claim 24, further comprising instructions that, when executed by one or more processors, cause the one or more processors to:
cause the user interface circuitry to present event timing to the user.
